(19) United States
(12) Patent Application Publication
(10) Pub. No.: US 2013/0016134 A1
(43) Pub. Date: Jan. 17, 2013

(54) ILLUMINATION APPARATUS, CONTROL METHOD THEREFOR, AND DISPLAY APPARATUS

(71) Applicant: Hironobu Hoshino, Inagi-shi (JP)

(72) Inventor: Hironobu Hoshino, Inagi-shi (JP)

(73) Assignee: CANON KABUSHIKI KAISHA, Tokyo (JP)

(21) Appl. No.: 13/529,656

(22) Filed: Jun. 21, 2012

(30) Foreign Application Priority Data
Jul. 15, 2011 (JP) 2011-156646

(51) Int. Cl. G02B 26/00; G09G 5/02; G09G 3/36; G09G 5/10

(52) U.S. Cl. 345/690; 359/290; 345/102

(57) ABSTRACT

A light source unit that forms a backlight of liquid crystal panel includes LEDs and a light guiding plate. A reflecting sheet is provided on a light guiding plate and the reflecting sheet is movable. Hole portions are formed in the reflecting sheet, and low reflecting portions are formed on the reflecting sheet. The reflecting properties in the reflecting sheet are changed by sliding the reflecting sheet, and the color gamut can be changed thereby.

### BACKGROUND OF THE INVENTION

1. Field of the Invention

The present invention relates to an illumination apparatus that can adjust a color gamut by the movement of a reflecting unit with respect to a light source unit.

2. Description of the Related Art

Conventionally, in the case in which, for example, a light emitting diode (below, abbreviated “LED”) is used in a light source, the color gamut of a backlight of an image display apparatus is determined by the wavelength component of the optical spectrum of the color gamut passing through an optical member. In combination with a liquid crystal panel, a color image display becomes possible within the range of the color gamut of the backlight by opening and closing liquid crystal shutters and by adjusting the display colors by using color filters. Therefore, for example, in order to realize an image replay apparatus in which an sRBG and AdobeRGB color gamut display is possible, it is necessary for the color gamut of the backlight to include both. Note that sRGB is the color space IEC 61966-2-1 that has been determined by the IEC (International Electrotechnical Commission). AdobeRGB is a color space that has been determined by Adobe Systems Corporation.

In this connection, in the case in which green in an sRGB color gamut is displayed on an image replay apparatus for which the color gamut of the backlight is AdobeRGB, because the color gamut of the backlight is broader than sRGB, the liquid crystal shutters must be adjusted, and the gradations of each color is sacrificed. As a specific example, the case in which sRGB green is displayed by “red 0, green 255, blue 0” (for the case in which each is 8 bits) will be explained. Under the AdobeRGB color gamut, not only to green, but also to red and blue liquid crystal shutters are opened, and “red 140, green 250, blue 80” (for the case in which each is 8 bits) is necessary. In addition, similar to the case in which the white color point is changed in association with the ambient light, because the adjustment by the liquid crystal shutters is necessary, the gradations of the brightness are sacrificed.

Thus, there is a method in which the light source of the backlight is formed not by white light, but by LEDs that emit each of the R (red), G (green), and B (blue) colors, and the color gamut is adjusted by changing the emission balance of the LEDs for each color. In addition, a method has been proposed in which coloring is applied to the surface of a diffusion plate of a backlight by using pigment to change the gradations (refer to Laid Open Japanese Patent Application No. 2003-279985).

However, the method in which a light source of a backlight is formed by LEDs having each of the R, G, and B colors and the emission balance of the LEDs for each of the colors is changed generally has a cost that is high in comparison to a white-light LED, the emission efficiency is low, and the control is complicated. In addition, in the technology disclosed in Laid Open Japanese Patent Application No. 2003-279985, the gradations of the backlight cannot be dynamically changed.

Thus, the illumination apparatus of the present invention dynamically controls the color gamut of the emission light without significantly influencing the gradations that can be displayed by a display device.

### SUMMARY OF THE INVENTION

An apparatus of the embodiments of the present invention is an illumination apparatus that controls the color gamut of the light from a light source unit by changing the reflection properties of a reflecting unit, and is provided with a drive unit that moves the reflecting unit having a plurality of reflecting portions with different reflectance ratios, and a control unit that controls the color gamut by changing the relative positions of the reflecting portions with respect to the light source unit by using the drive unit.

According to the present invention, the color gamut of the light emitted from an illumination apparatus can be dynamically changed, and the gradations that can be displayed can be prevented from deteriorating.

Further features of the present invention will become apparent from the following description of exemplary embodiments (with reference to the attached drawings).

### BRIEF DESCRIPTION OF THE DRAWINGS

FIG. 1A and FIG. 1B are structural diagrams that show a reflecting member of an illumination apparatus for explaining, in conjunction with FIG. 2A to FIG. 5B, a first embodiment of the present invention.

FIG. 2A is a cross-sectional view that illustrates a schematic structure of the illumination apparatus.

FIG. 2B is a frontal view of the reflecting member that illustrates a schematic structure of the illumination apparatus.

FIG. 3A is a cross-sectional view that illustrates the schematic structure of the illumination apparatus in a different state from those in FIG. 2A and FIG. 2B.

FIG. 3B is a frontal view of the reflecting member that illustrates the schematic structure of the illumination apparatus in a different state from those in FIG. 2A and FIG. 2B.

FIG. 4A and FIG. 4B are drawings that illustrate the reflectance ratios of a plurality of reflecting members.

FIG. 5A is a drawing that illustrates the optical spectrum of the illuminating light in a first and second state.

FIG. 5B is a drawing that illustrates the color gamut of the illuminating light in a first and second state.

FIG. 6 is a block diagram that illustrates the schematic structure of an illumination apparatus for explaining, in conjunction with FIG. 7 to FIG. 8B, a second embodiment of the present invention.

FIG. 7 is a flowchart for explaining an example of the control of the illumination apparatus.

FIG. 8A and FIG. 8B are drawings that show each of the states of the reflecting member of the illumination apparatus.

### DESCRIPTION OF THE EMBODIMENTS

Below, each of the embodiments of the present invention will be explained with reference to the figures.

### First Embodiment

A first embodiment of the present invention is an example in which the color gamut is adjusted by sliding, among a plurality of reflecting sheets, the sheet on the front surface side to change the reflectance ratio of the reflecting sheet.

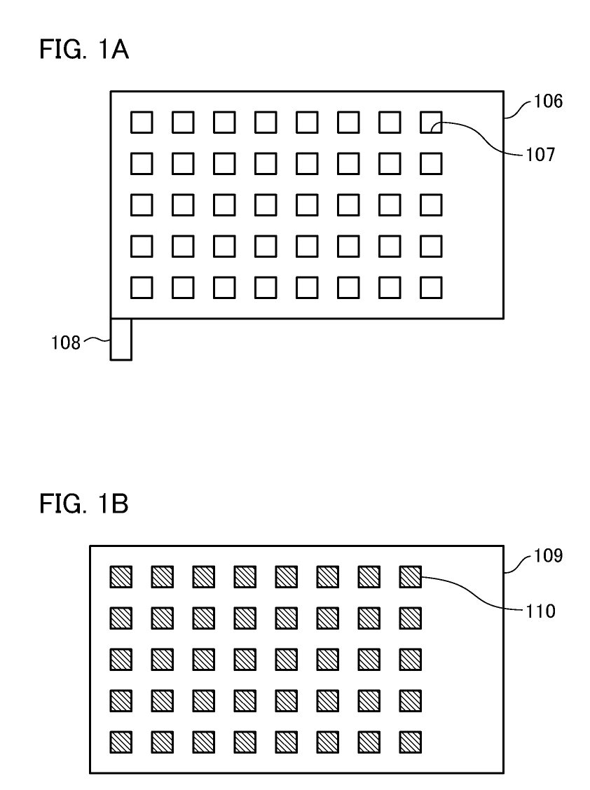

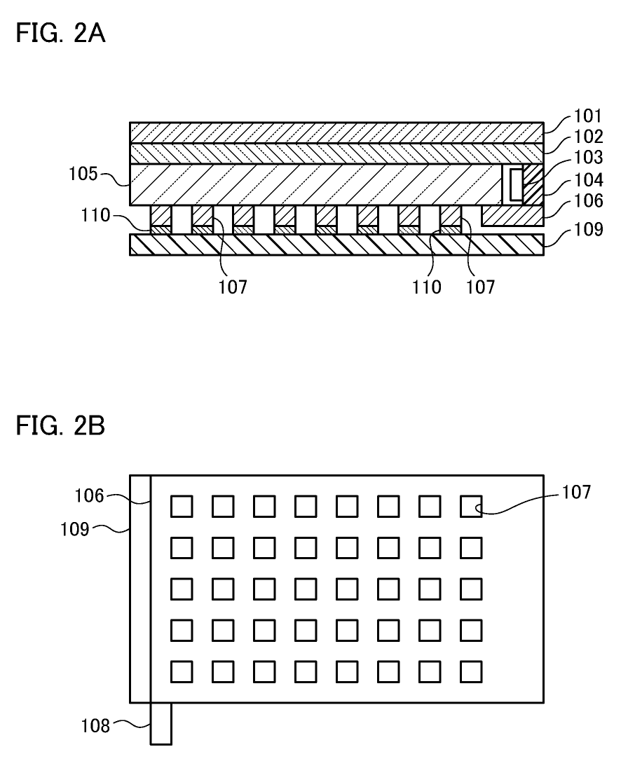

Before explaining the reflecting members of the illumination apparatus that is shown in FIG. 1A and FIG. 1B, the apparatus configuration will be explained. FIG. 2A is a cross-sectional view that shows an example of a configuration of the illumination apparatus according to a first embodiment of the present invention. Note that below, an edge light-type backlight that uses a light guiding plate will be explained as the illumination apparatus. The viewing side of the display unit will be referred to as the “front surface direction” and the “anterior surface direction”.

The liquid crystal panel 101 used in a display unit is a display apparatus that can adjust the transmitted amount of light by allowing transmission of, among the light components received from the back surface side, only the polarized components having a specific direction in a liquid crystal layer (not illustrated). Image content is provided to a user by adjusting the transmittance amount of the pixels, which are used in display units such as television receivers, computer devices, mobile telephones and the like, and have color filters (not illustrated) adhered. The liquid crystal panel 101 of the present embodiment has a horizontal resolution of 1920 pixels and a vertical resolution of 1080 pixels, and carries out image display by receiving an image signal from a display controller (not illustrated).

A diffusion sheet 102 is disposed on the back surface of the liquid crystal panel 101, and the light from the light source unit is diffused by dispersion. In the present example, a transparent film that has a polyethylene terephthalate (PET) material serving as a base is used, and light having little brightness unevenness or color unevenness is provided to the liquid crystal panel 101. In an LED 103, which serves as the light emitting element that forms the light source unit, a white light LED is used, and the amount of light thereof is determined by controlling the amount and the supply time of power supplied from an electrical power source (not illustrated). The base 104 of the LED 103 is formed by adhering an aluminum material to a glass epoxy substrate. The base 104 includes the effect of radiating heat generated by the LED 103 from the aluminum material, in addition to the function of attaching the LED 103 and a wiring function that supplies electric power thereto.

The light guiding plate 105 is a light guiding member for delivering the incident light from the LED 103 toward the liquid crystal panel 101, and in the present example, the plate is an acrylic plate to which dot printing has been applied using white ink on the anterior surface that opposes the liquid crystal panel 101. This includes a dispersion and diffusion effect for guiding the light from the LED 103 to the liquid crystal panel 101 and delivering the light uniformly. The LED 103 is positioned in proximity to the side surface of the light guide plate 105. The reflecting sheet 106, which is disposed on the back surface of the light guiding plate 105, is a sheet made of a PET material and has a high reflectance ratio for visible light rays. The reflecting sheet 106 is a movable first reflecting member that includes a reflecting portion that reflects light from the light guiding plate 105 and a transmitting portion that transmits a portion of the light from the light guiding plate 105. The transmitted light that has passed through the transmitting portion of the reflecting sheet 106 is reflected by a second reflecting member, to be described below, and returns to the light guiding plate 105. FIG. 1A is a drawing viewed from the anterior surface side, and a plurality of hole portions 107 is formed in the reflecting sheet 106. These are arranged vertically and horizontally with uniform gaps therebetween, and the light transmitted from the light guiding plate 105 is reflected by the reflecting sheet 109 via the hole portions 107. The reflecting sheet 109 is a second reflecting member that includes a plurality of reflecting portions. The lever 108 that is provided on the reflecting sheet 106 has the role of sliding the reflecting sheet 106 independently of the other members. Note that the movement of the lever 108 is carried out by a drive unit and a drive control unit (not illustrated) or is carried out according to an operation of a user.

The reflecting sheet 109 on the back surface side is a sheet made of the same material as that of the reflecting sheet 106 on the front surface side. FIG. 1B illustrates the reflecting sheet 109 when viewed from the anterior surface side, and is the portion by which the light that has passed through the hole portions 107 of the reflecting sheet 106 is delivered. A coating having reflection properties that differ from those of the other portions is applied to the low reflecting portions 110. Similar to the hole portions 107, a plurality of low reflecting portions 110 is arranged vertically and horizontally with a fixed gap therebetween.

Next, the mechanism by which the color gamut is changed will be explained with reference to FIG. 2A to FIG. 5B.

FIG. 2A shows a first state in which a reflecting sheet 106 on the front surface is slid to the side (toward the right in the figure) in proximity to the LED 103. This is a state in which the low reflecting portions 110 of the reflecting sheet 109 are covered and hidden by the portions in which the hole portions 107 are not formed in the reflecting sheet 109. FIG. 2B is a drawing, viewed from the anterior surface, in which the reflecting sheet 106 on the front surface side and the reflecting sheet 109 on the back surface side are set in an overlapping state. In the reflecting sheet 109, the portion to which the low reflecting coating has not been applied is exposed from the hole portions 107 of the reflecting sheet 106. That is, this is a state in which, at the reflecting sheet 109, the reflectance ratio with respect to visible light rays is high.

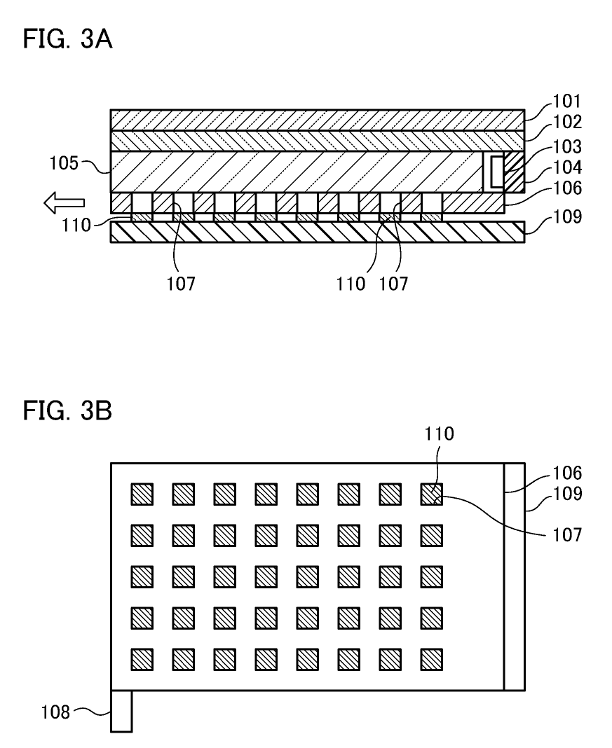

In contrast, FIG. 3A is a cross-sectional view that shows a second state in which the reflecting sheet 106 on the front surface side has been slid from the state in FIG. 2A in the direction opposite to the direction (toward the left in the figure) of the LED 103 by using the lever 108. FIG. 3B is a drawing, viewed from the anterior surface, in which the reflecting sheet 106 on a front surface side and the reflecting sheet 109 on the back surface side are set in an overlapping state. The low reflecting portions 110 of the reflecting sheet 109 are exposed from the hole portions 107 of the reflecting sheet 106, and light that reaches and is reflected by the low reflecting portion 110 returns to the anterior surface side. That is, the reflectance ratio of the reflecting sheet 109 changes to a state that differs from that shown in FIG. 2B by sliding the reflecting sheet 106 on the front surface side in a direction that is perpendicular to the reflecting direction of the low reflecting portion 110. Note that actually the light path changes due to the material and reflectance ratio of the portions through which the light passes, but here, in order to simplify the explanation, an explanation will be provided in which a coating having a low reflectance ratio only with respect to green light is applied to the low reflecting portion 110. In addition, the emitted light from the backlight is assumed to be light for which the transmission properties of visible light are not influenced by the light guide plate 105 and the diffusion sheet 102, and it is assumed all of the light that passes through the hole portions 107 is emitted from the diffusion sheet 102 toward the front surface side after being reflected by the reflecting sheet 109.

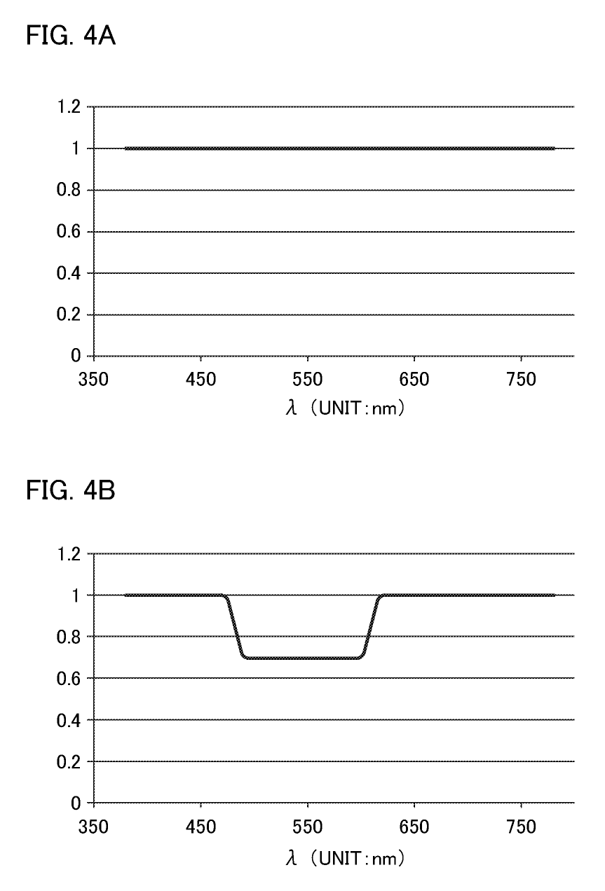

FIG. 4A illustrates the reflection properties of the reflecting sheets 106 and 109 in the first state that is shown in FIG. 2A and FIG. 2B. In addition, FIG. 4B illustrates the reflection properties of the reflecting sheets in the second state that is shown in FIG. 3A and FIG. 3B. The horizontal axis represents the wavelength λ (unit: nm (nanometer)), and the vertical axis represents the reflectance ratio. In FIG. 4A, the reflectance ratio is 100%, irrespective of the wavelength A. In addition, in FIG. 4B, the reflecting properties show an attenuation of about 30% centered near the 550 nm wavelength.

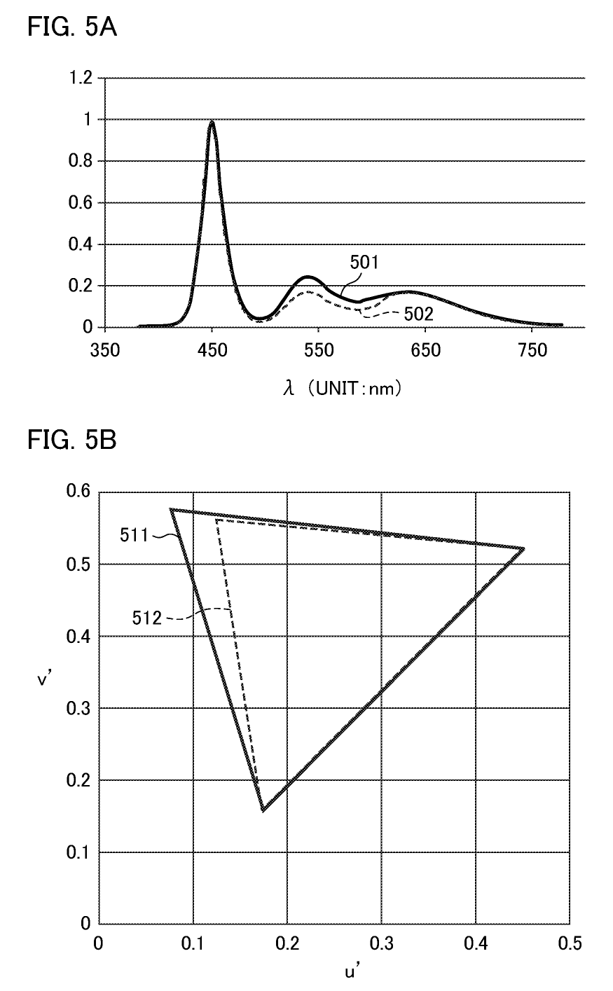

FIG. 5A illustrates the optical spectrum of the light irradiated from the LED 103, where the horizontal axis represents the wavelength A (unit: nm (nanometer)) and the vertical axis represents the intensity of light in arbitrary units, where the peak intensity near 450 nm is set to 1. The light that is irradiated from the LED 103 in the first state that is shown in FIG. 2A and FIG. 2B is reflected by reflecting sheets having the uniform reflecting properties that are shown in FIG. 4A. Therefore, because the light that is emitted from the diffusion sheet 102 does not change with respect to the light of the LED 103, the optical spectrum of the graph line 501 that is shown by a solid line in FIG. 5A can be obtained. This color gamut attains a range within the inverted triangular frame 511 that is shown by the solid line in FIG. 5B. In the present example, a UCS chromaticity diagram defined by the Commission Internationale de l'Eclairage (CIE), that is, a u′v′ chromaticity diagram (CIE 1976), is shown.

In contrast, in the second state that is shown in FIG. 3A and FIG. 3B, a portion of the light incident to the light guiding plate 105 after being irradiated from the LED 103 is reflected by the reflecting sheet having the reflection properties that are shown in FIG. 4B. Therefore, an optical spectrum of the graph curve 502 that is shown by the broken line in FIG. 5A can be obtained for the light emitted from the diffusion sheet 102. This color gamut attains the range within the inverted triangular frame 512 that is shown by the broken line in FIG. 5B. That is, the color gamut of the green light can be narrowed by attenuating the optical intensity of the wavelength near 550 nm by sliding the reflecting sheet 106 on the front surface side.

In the present embodiment, an edge-light-type back light was illustrated and explained, but the color gamut can be similarly changed by the movement of a reflecting sheet in a directly-under-type backlight. Thereby, the gradations that can be displayed by the liquid crystal panel can be prevented from deteriorating. In addition, the color gamut can be similarly changed by the movement of the reflecting sheet in embodiments that use LEDs for each RGB color in the light source as well. In the above example, the adjustment of the color gamut was explained, but in an illumination apparatus provided with a sensor (not illustrated) that measures the ambient light, control in which the color temperature of a white light source is changed depending on the ambient light can be carried out in tandem. In addition, a configuration in which a first reflecting member is a stationary member and the second reflecting member is a movable member and a structure in which a reflecting unit is formed by using three or more types of reflecting sheets and one or more of the reflecting sheets among these types is moved and the like become possible.

According to the first embodiment, among a plurality of reflecting members, the reflectance ratio in a specified wavelength region can be changed by sliding a predetermined reflecting member. Thus, the color gamut and the white color point of the light that is emitted from the illumination apparatus can be dynamically controlled. As a result, a deterioration of the gradation capability that can be displayed by a display panel can be restrained.

### Second Embodiment

Next, a second embodiment of the present invention will be explained. In the second embodiment, control is executed in which the color gamut is automatically changed according to an operation command by the user or the displayed image on the screen. Note that reference numerals that have already been used for structural elements that are identical to those of the case of the first embodiment are used in the second embodiment. Thereby, the detailed explanation thereof will be eliminated and the points of difference between the first embodiment and the second embodiment will be explained.

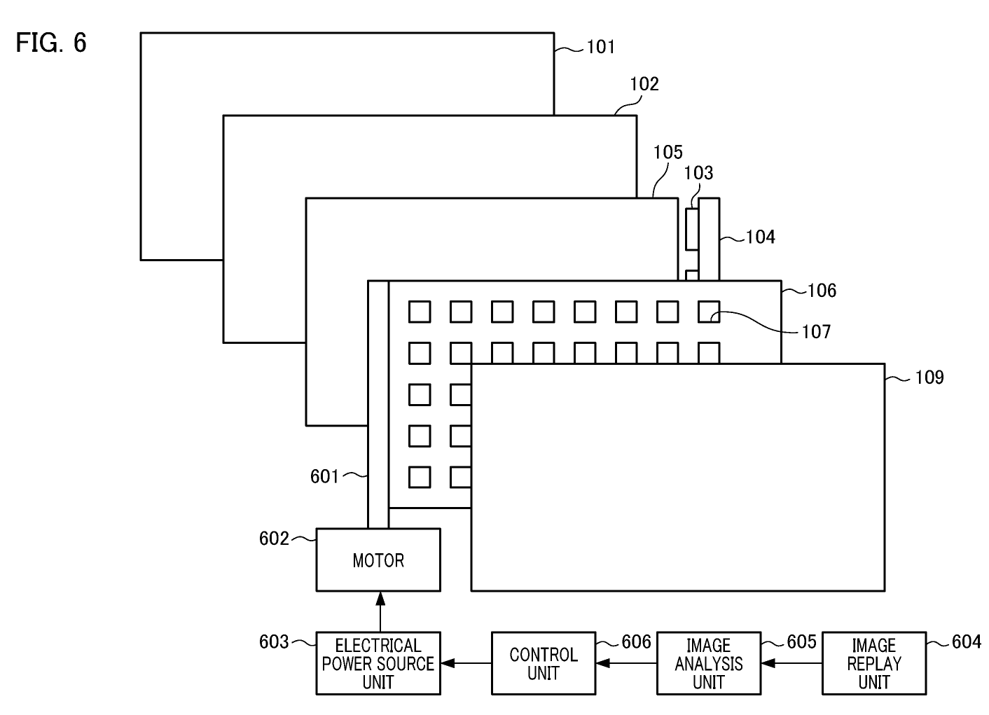

FIG. 6 is an exploded view that shows the principal components of the structure.

A slide shaft 601 is driven by the rotation of a motor 602, and the reflecting sheet 106 on the front surface side is slid by being wound. That is, the motor 602 is a drive unit that changes the relative positions of the reflecting sheet 106 with respect to the light guide plate 105. Thereby, transitioning between the first state that is shown in FIG. 2A and FIG. 2B and the second state that is shown in FIG. 3A and FIG. 3B, and transiting to the state of a color gamut corresponding to an arbitrary position therebetween become possible. The motor 602 receives the electric power supply from an electrical power source unit 603, and the control unit 606 changes the drive amount and the rotation direction by controlling the electric power source unit 603.

An image replay unit 604 replays an image signal of an image that is displayed on the liquid crystal panel 101, and sends the image signal to an image analysis unit 605. The image analysis unit 605 analyzes the image signal, and the result of the analysis of the displayed colors is sent to the control unit 606. The expression “analysis processing” denotes processing in which the RGB values of each of the pixels of the image are changed to u′v′ chromaticity coordinates of a u′v′ chromaticity diagram (CIE, 1976).

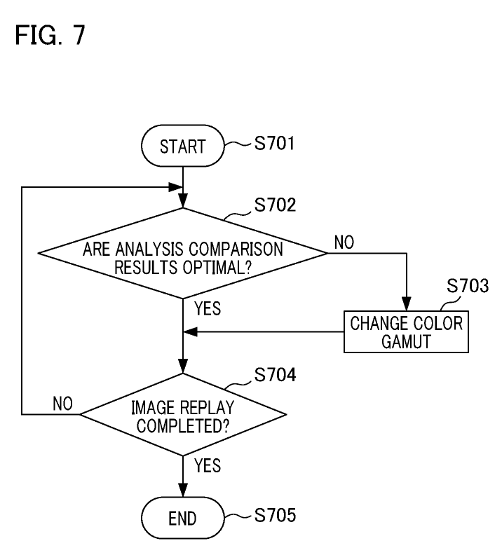

Next, the processing that is carried out by the control unit 606 will be explained with reference to the flowchart in FIG. 7.

In S701, control starts at the same time as the image replay. Next, in S702, the control unit 606 compares the results of analysis from the image analysis unit 605 with the color gamut. That is, the color gamut shown in FIG. 5B is plotted on the u′v′ chromaticity diagram of the image, and a comparison is carried out to determine whether or not all of the displayed colors for each pixel data are included in the color gamut. As a result, in the case in which it has been determined that all of the displayed colors of the pixel data are included in the range shared in each color gamut (refer to frames 511 and 512) that is shown in FIG. 5B, if the illumination apparatus is in a broad color gamut state at the current point in time, the processing moves to S703 in order to change to a narrow color gamut state. In contrast, in the case in which it has been determined that the color gamut at the current point in time is an optimal state, the process proceeds to step S704. In addition, in the case in which the displayed colors of the pixel data are not included in either color gamut, the process proceeds to S703, in which a broader color gamut is attained.

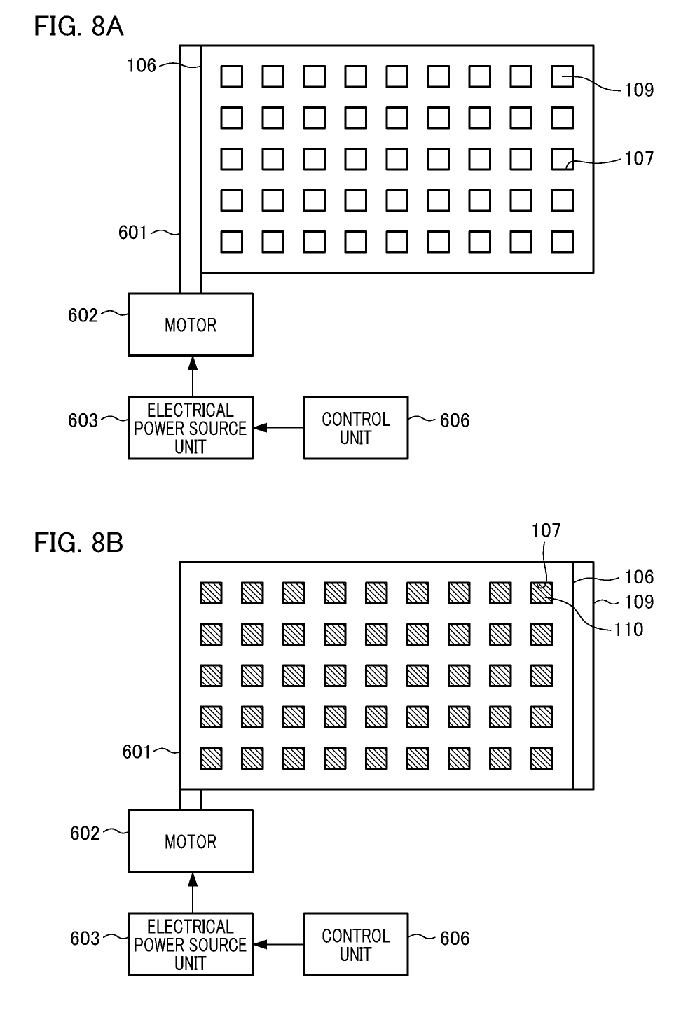

In S703, the control unit 606 outputs a command to the power source unit 603 so as to change the color gamut of the light that is emitted from the backlight depending on the result of the determination in S702. As a result, control is carried out such that the slide shaft 601 is driven by the motor 602, and an optimal color gamut is obtained depending on the amount of movement of the reflecting sheet 106. For example, the control unit 606 executes slide control of the reflecting sheet 106 such that the first state that is shown in FIG. 8A is attained in the case in which the broadest color gamut is set or the second state that is shown in FIG. 8B is attained in the case in which the narrowest color gamut is set.

S704 is a process that determines whether or not the image replay has completed, and in the case in which the image replay has not completed, the process returns to S702 and processing is repeated. In addition, in the case in which it has been determined that the image replay has completed, the sequence of the processing is ended.

The slide position of the reflecting sheet 106 is not limited to two stags, and the reflecting area of the reflecting portion can be changed in three or more stages or continuously. Specifically, because the movement of the reflecting sheet 106 can be stopped at an intermediate stage, the color gamut of the middle region can be adjusted. In this circumstance, the invention of the present application is not limited to control in which an image signal is analyzed and the color gamut is automatically adjusted according to the result of the analysis, and the color gamut can also be changed according to a setting or an operational command of a user. Specifically, the control unit 606 obtains an operation command signal from an operation unit or a setting unit (not illustrated) for the color gamut, and sliding control of the reflecting sheet 106 is carried out by driving a motor 602 similar to the above.

According to the second embodiment, by moving a reflecting member according to a user command or a displayed image, the color gamut of light emitted from an illumination apparatus can be dynamically changed.

Note that in the above embodiments, for the sake of convenience, an example was explained in which a coating having a low reflectance ratio in the wavelength region of green color was applied to the reflecting sheet 109 such that the green color region is narrowed at the low reflecting portion 110. This is simply an example, and the color gamut can be adjusted by applying a plurality of coatings having differing reflectance ratios in different wavelength regions to the reflecting sheet.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-156646 filed Jul. 15, 2011 which is hereby incorporated by reference herein in its entirety.

What is claimed is:

1. An illumination apparatus that controls a color gamut of light from a light source unit by changing the reflection properties of a reflecting unit, comprising:
a drive unit that moves the reflecting unit having a plurality of reflecting portions with differing reflectance ratios; and
a control unit that controls the color gamut by changing the relative positions of the reflecting portions with respect to the light source unit by using the drive unit.

2. The illumination apparatus according to claim 1, wherein the reflecting unit comprises:
a first reflecting member that includes a transmitting portion and a reflecting portion for the light from the light source unit; and
a second reflecting member that includes a reflecting portion that reflects the light that has passed through the transmission portion at a reflectance ratio that differs from that of the reflecting portion;
wherein the drive unit moves the first reflecting member.

3. The illumination apparatus according to claim 2,
wherein the reflectance ratio of the reflecting portion formed in the second reflecting member is lower than the reflectance ratio of the reflecting portion of the first reflecting member, and
wherein the reflecting area of the reflecting portion of the second reflecting member changes with respect to light from the transmitting portion due to the movement of the first reflecting member.

4. The illumination apparatus according to claim 3, wherein the transmitting portion of the first reflecting member is a plurality of hole portions that are formed in the reflecting portion.

5. The illumination apparatus according to claim 2, wherein
the light source unit includes a light guiding member and a light emitting element opposed to the light guiding member;
a portion of the light from the light emitting element incident to the light guiding member reaches the reflecting portion of the second reflecting member from the transmitting portion of the first reflecting member and is reflected to return to the light guiding member; and
the drive unit moves the first reflecting member in a direction perpendicular to the reflecting direction of the reflecting portion of the second reflecting member.

6. A display apparatus comprising:
a display unit that carries out image display according to an image signal; and
the illumination apparatus according to claim 1.

7. A display apparatus according to claim 6, wherein the control unit changes the color gamut of the illumination apparatus by controlling the drive unit according to an operation command signal.

8. A display apparatus according to claim 6, further comprising:
an image analysis unit that analyzes an image signal,
wherein the control unit obtains the result of analysis from the image analysis unit and changes the color gamut to a color gamut that includes the display colors that have been analyzed by the image analysis unit by controlling the drive unit.

9. A control method executed in an illumination apparatus comprising a reflecting unit that reflects light from a light source unit, and a drive unit that changes the color gamut by changing the reflection properties by moving the reflecting unit,
wherein the color gamut is controlled by moving the reflecting unit having a plurality of reflecting portions with differing reflectance ratios by the drive unit and changing the relative position of the reflecting portions with respect to the light source unit.
